(19) United States
(12) Patent Application Publication
(10) Pub. No.: US 2008/0196688 A1
(43) Pub. Date: Aug. 21, 2008

(54) Internal Combustion Engine

(76) Inventor: Savvas Savvakis, Athens (GR)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/996,512

(22) PCT Filed: Jun. 2, 2006
(86) PCT No.: PCT/GR06/00027

§ 371 Date: Jan. 23, 2008

(30) Foreign Application Priority Data
Aug. 1, 2005 (GR) 20050100405
Jun. 2, 2006 (GR) PCT/GR2006/000027

(51) Int. Cl. F02B 53/00; F02B 55/10

(52) U.S. Cl. 123/240; 123/41.56

(57) ABSTRACT

An engine with expansion piston located on the end of a motion arm connected to the engine shaft. On the shaft, rotating compression pistons are mounted. The distance between the two piston types allows for the production of great torque. The geometry of expansion chamber and compression chamber is concentric toroidal. A pressure chamber stores the air-fuel mixture coming from the compression chamber to the expansion chamber and is therefore interposed between the two. The timing of the two or more sliding ports attached to the compression chambers determines the compression volume, while the valves control the communication of the pressure chamber with the other chambers.

The current invention request describes the function of a rotary motor which may replace the existent internal combustion engines in most of their today applications.

This engine has the following special structural characteristics:

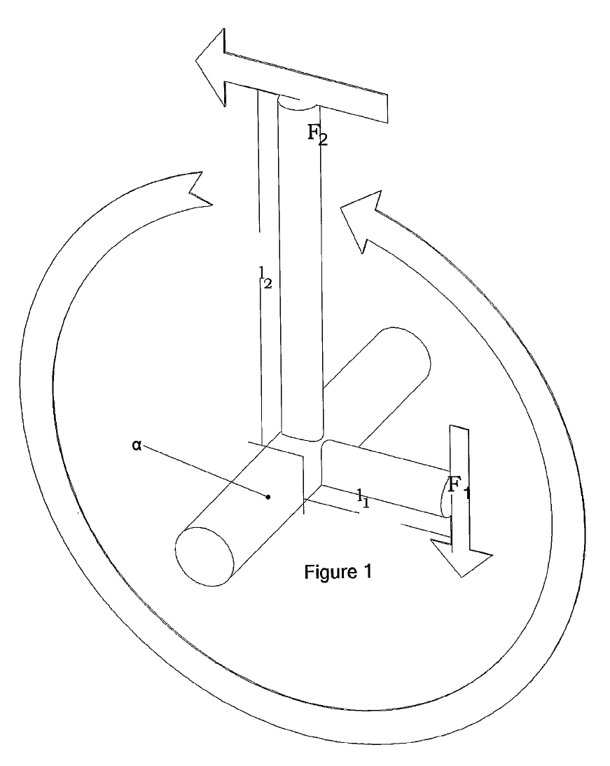

A) what is important to an engine is the output torque of its engine-shaft, (crankshaft in the case of a reciprocative motor). In order to maximize this torque, it is necessary to maximize the torque that is produced on the engine-shaft because of the exhaust gas' expansion as well as to minimize the resistant torque produced by the air or air-fuel mixture compression. Generally, the torque is defined as the product of the applied force vector times the vector from the axis of rotation to the point on which the force is acting. Thus, it is easy to imagine an axis (α) on which two arms are located, with lengths L₁ and L₂ for the compression and expansion process, respectively (FIG. 1). If the forces of compression and expansion, F₁ and F₂, are applied respectively on the edge of the two arms, L₁ and L₂, in order to minimize the torque that produced on the compression-arm L₁, it is necessary to minimize or even zero the length of the compression-arm. On the contrary, in order to maximize the expansion-torque produced by the force F₂ on the expansion-arm, it is necessary to have an expansion-arm L₂ as long as possible. In the case of compression, this can be easily succeeded by locating the compression-chamber and its piston (compression piston) on the cylindrical surface of the engine-shaft. In this way, the length of the compression-arm is equal to zero and the distance between the compression force and the gudgeon of the engine-shaft (α) minimal. In the case of expansion, the expansion-arm L₂ must be as long as the available space of the engine allows. Applying a force (the expansion force) on the free edge of this arm, the longer the arm, the greater the torque that will be applied on the shaft (α). That means, the compression-piston is recommended to be located directly on the engine-shaft while the expansion-piston on an arm attached to the shaft maximizing the piston's distance from the shaft. All pistons are moving in circular orbits whose planes are vertical to the gudgeon of the engine-shaft and have a cylindrical shape, with the axis of their cylinder to be coincident with the ring tour of their motion (that means the cylinder axis is not a straight line, but makes a curve). The sealing of the pistons is easy, using the rings that have been developed for the reciprocative motors' pistons. The combustion-chamber is formed by a ring shaped fixed shell, which surrounds the cylindrical surface of the expansion-piston, and a moving wall that is necessary to retain the sealing of the chamber in the whole duration of the synchronous motion of the expansion-piston with its arm.

B) The current motor has one piston for the intake and the compression of the air and one piston for the combustion of the fuel-air mixture and the expansion of the exhaust gases. The pistons are moving on a circle round the gudgeon of the engine-shaft. The combustion and expansion process actuates the expansion-piston on a circular motion. The expansion-piston actuates in rotation the motion-arm and the latter the engine-shaft. Finally, the engine-shaft's rotation actuates the compression-piston. At the same time of the expansion process of an operating cycle, the compression process of the next operating cycle is in progress.

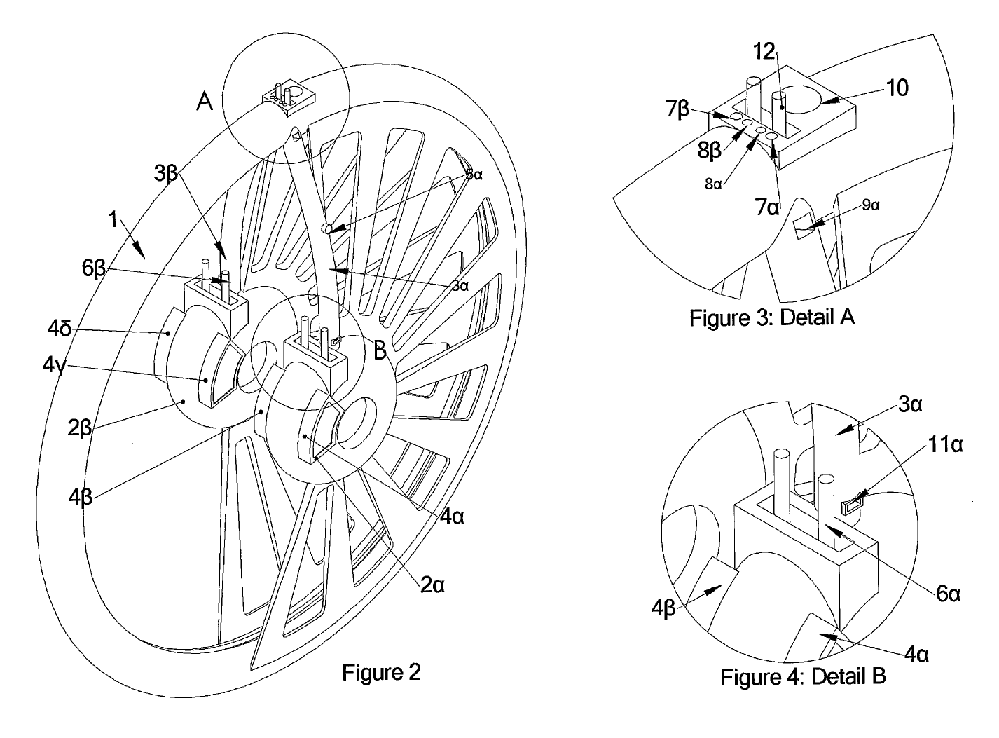

C) The current motor needs three chambers for the completion of its operating cycle (FIG. 2). One chamber for the intake and compression of the combustion air or fuel-air mixture (compression chambers 2α and 2β), one chamber for the storage of air or fuel-air mixture under high pressure (pressure chambers 3α and 3β) and a chamber for the combustion of the fuel-air mixture and expansion of the exhaust gases (combustion chamber 1). The pressure chamber contains air or fuel-air mixture whose pressure has the same value with the pressure that is able to guide the fuel-air mixture in the combustion chamber to ignition. In the case of storing fuel-air mixture in the pressure chamber, the mixture must be stored under pressure lower enough of the auto-ignition pressure of the mixture making the presence of spark plugs necessary inside the combustion chambers in order to start the ignition (8α and 8β). The spark-plugs increase the temperature of the mixture to the ignition temperature (that means they create the appropriate conditions to start the combustion) (FIG. 3). Since the combustion chamber is far enough from the compression chamber, a single connection canal between these two chambers would provide the expansion of the compressed air or air-fuel mixture inside the canal, during its transfer from the one chamber to the other, so that the final pressure of the air or air-fuel mixture, as they entered the combustion chamber, would be less than the desired and the combustion and expansion process would be significantly weaker. In the case of using a single transfer canal and compressing the air or air-fuel mixture in a pressure much higher than the desired in order for the fluid to reach the combustion chamber with a pressure close to the desired, in spite of its expansion inside the canal, the canal's volume is so big, in comparison to the volume of the compressed air or air-fuel mixture, that the compression rate must be too high and a significant part of the effective torque would be lost with no reason. Moreover, there must be an extra reinforcement for the materials in order to withstand the higher pressure. In order to avoid these problems, the current rotary motor has a third chamber between the compression and combustion chamber, the pressure chamber. Because of the long distance between the compression and combustion chamber, the pressure chamber is located between these two chambers in order to ensure that the pressure of the air or air-fuel mixture at the end of the compression process in the compression chamber will be the same with the pressure of the air or air-fuel mixture during its entering into the combustion chamber, without spending part of the effective power or demanding extra reinforcement of the engine's materials. The compression and combustion chamber are connected only with the pressure chamber, while their direct intercommunication is not possible because of their distance. The communication between the compression and pressure chamber is possible through a valve that can be either an one-way solenoid valve—from the compression chamber to the pressure chamber—(11α FIG. 4) which allows the transit of the air or air-fuel mixture only when the pressure in the compression chamber is equal to or greater than the pressure in the pressure chamber. Once the sliding port of the compression chamber opens (6α and 6β—FIGS. 2 and 4), the pressure in the compression chamber reduces because the compressed air is mixed with the atmospheric air from the induction chamber and the one-way valve (11α) seals. For the communication of the pressure chamber with the combustion chamber a one-way solenoid valve is also used (from the pressure chamber to the combustion chamber) (9α FIG. 3), electronically controlled. Finally, every pressure chamber has a relief-valve (5α FIG. 2) in order to avoid the extreme increase of pressure inside the pressure chamber because of the high temperature that could developed through the motor operation or hot climate.

The invention will now be described by way of example and with reference to the accompanying drawings in which the recommended details are not obligating for the construction of the engine. The dimensions are indicative and the figures are aiming to the better understanding of the aforementioned description. Using the up-to-date know-how of the existing motors may improve the designation of this motor even more. All the details that are not depicted on the following figures are omitted on purpose because they can be parts of the existent motors, such as the fuel-feed and fuel-injection system:

FIG. 1: An engine-shaft with two arms (a compression- and an expansion-arm)

FIG. 2: The fixed part of the motor with the sliding ports of the compression- and combustion-chambers.

FIG. 3: Detail A of FIG. 2 for the better observation of the parts of the pressure- and combustion-chamber

FIG. 4: Detail B of FIG. 2 for the better observation of the parts of the pressure- and compression-chamber

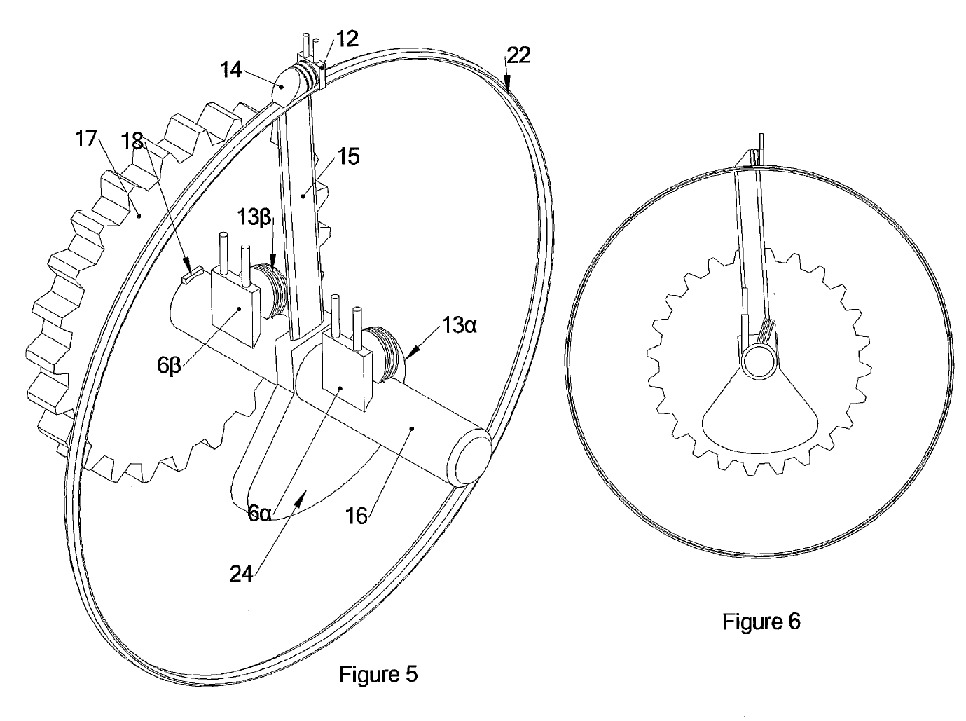

FIG. 5: The sliding ports and the moving part comprising of the engine-shaft, the motion-arm, the moving wall of the combustion chamber and the pistons

FIG. 6: Another point of view of the FIG. 5

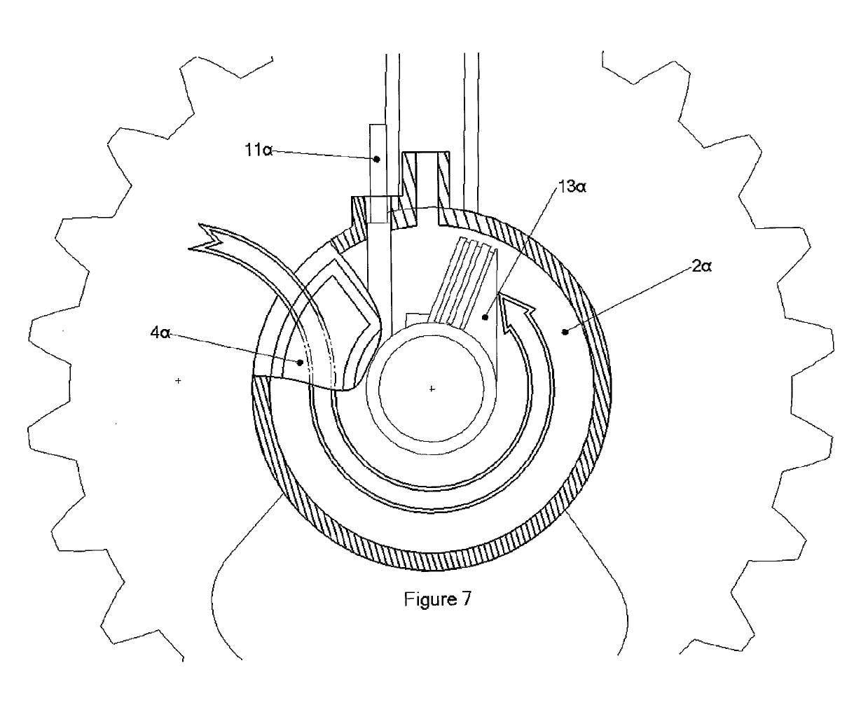

FIG. 7: The intake phase of the atmospheric air.

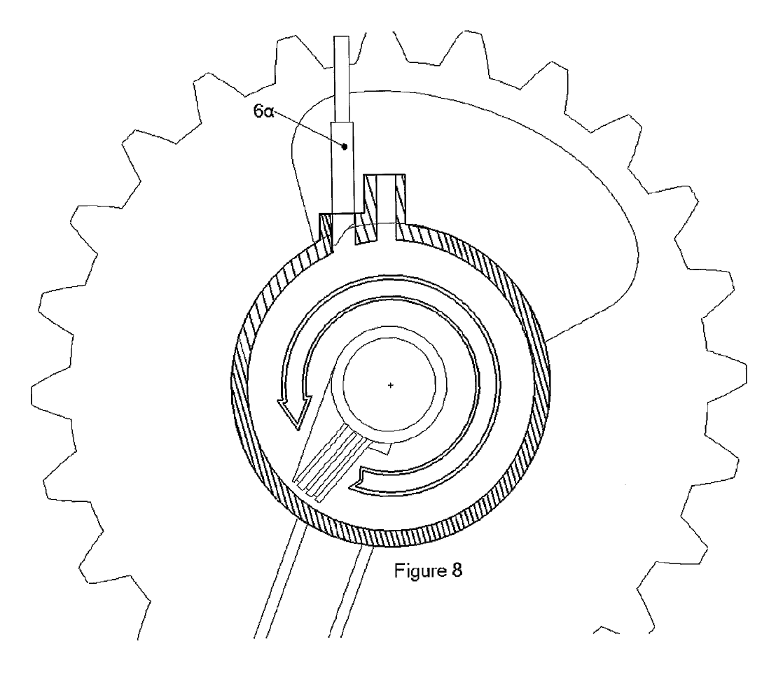

FIG. 8: The phase of free motion of the compression-pistons inside the compression-chambers.

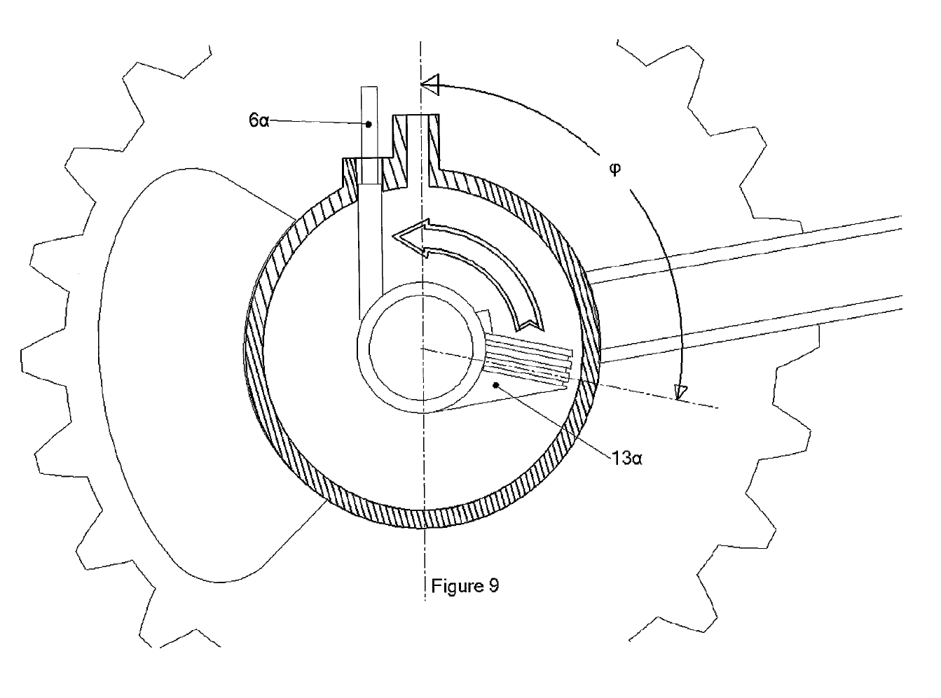

FIG. 9: The time when the compression process starts.

FIG. 10: The final stage of the compression process.

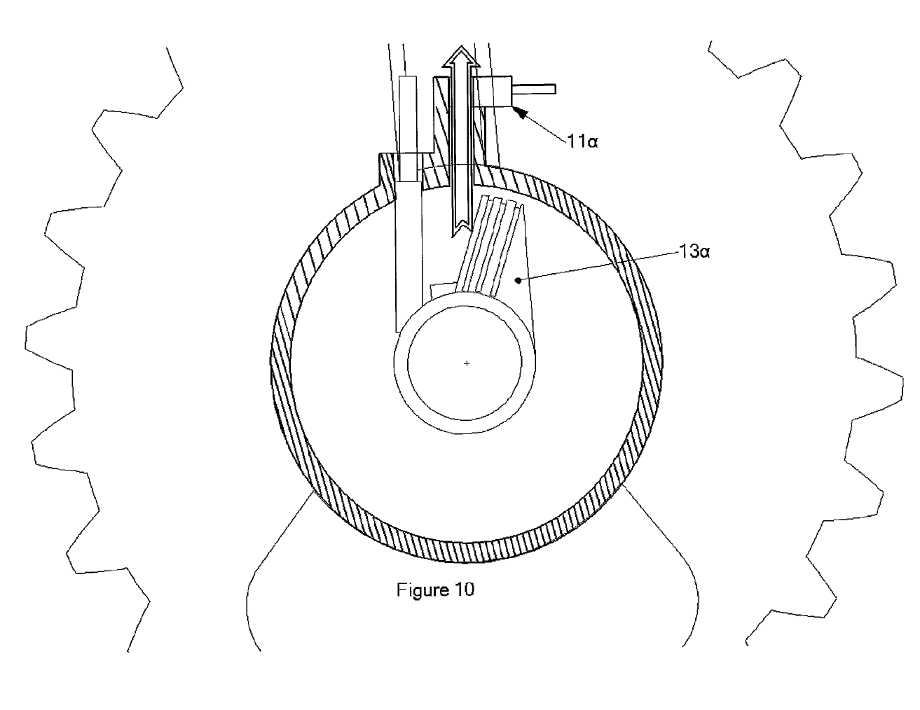

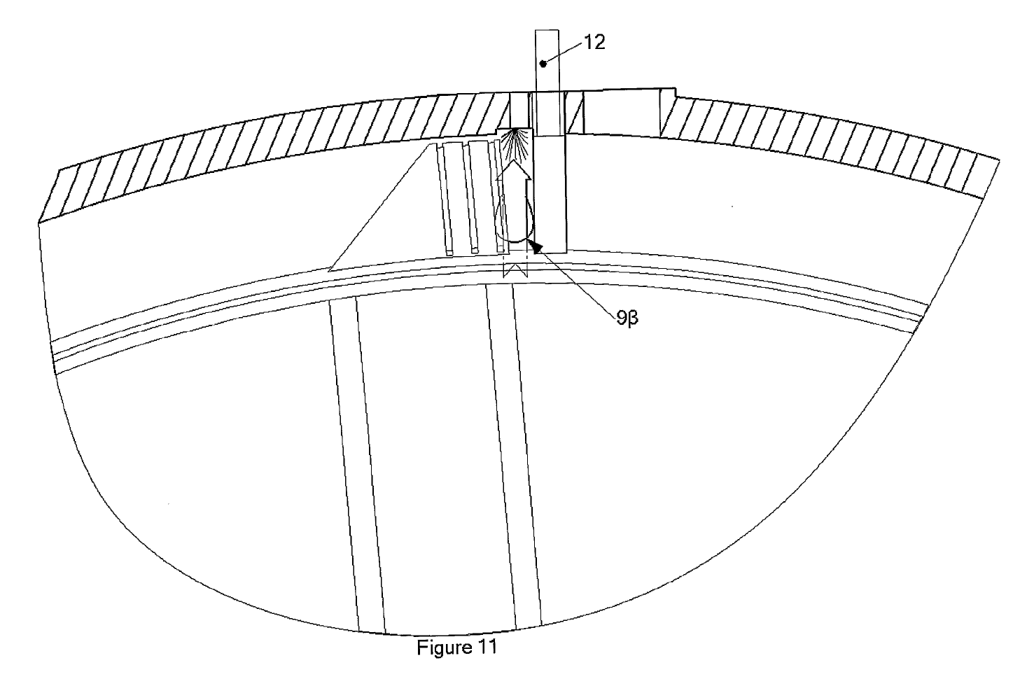

FIG. 11: The entrance of the air or fuel-air mixture into the combustion-chamber from the pressure-chamber (final stage of the compression process)

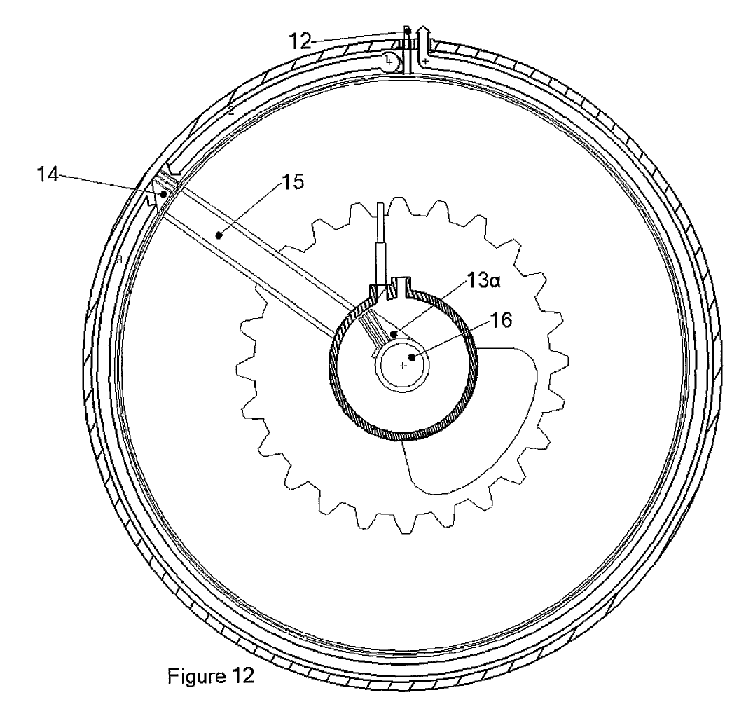

FIG. 12: Phase of combustion, expansion and how the exhaust gases are removed.

FIG. 13: the circulation of water cooling

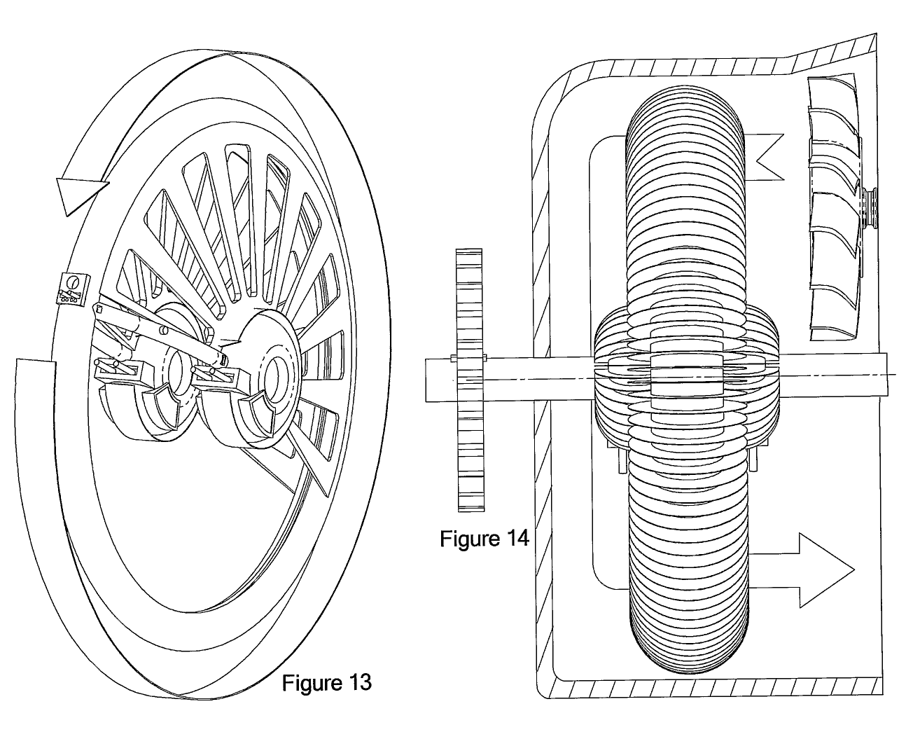

FIG. 14: the external air-cooling system of the engine

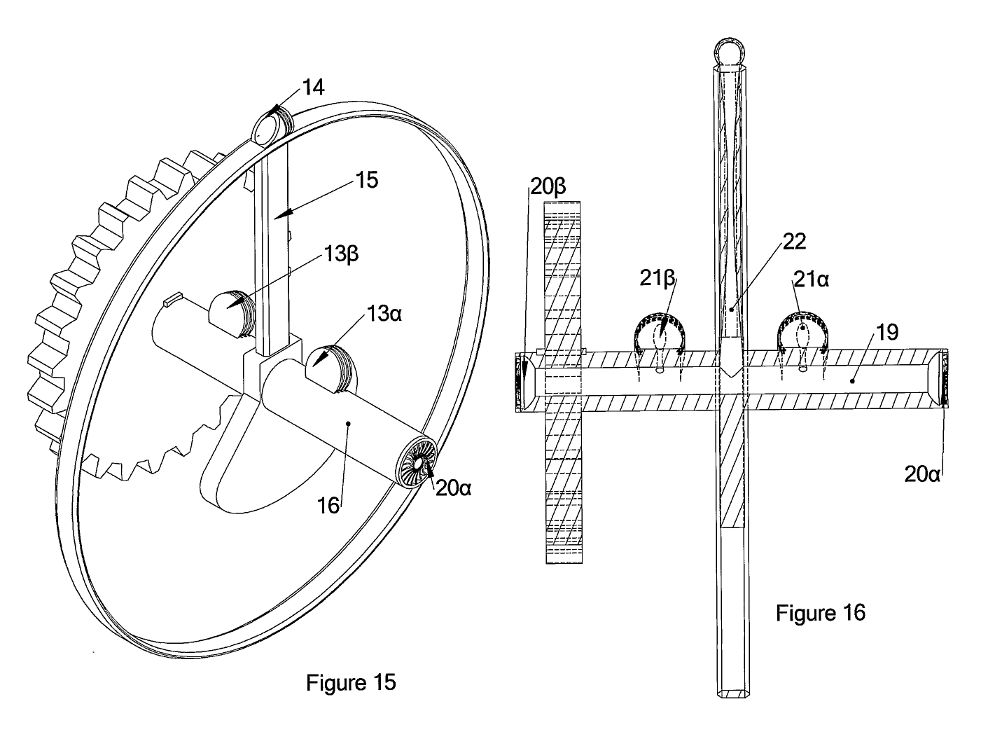

FIG. 15: The moving part comprising of the engine-shaft, the motion-arm, the moving wall of the combustion chamber and the pistons in case of the internal air-cooling

FIG. 16: Cross-section of the moving part that is illustrated in FIG. 15

FIG. 17: FIG. 15 with the circulation arrows of the cooling air.

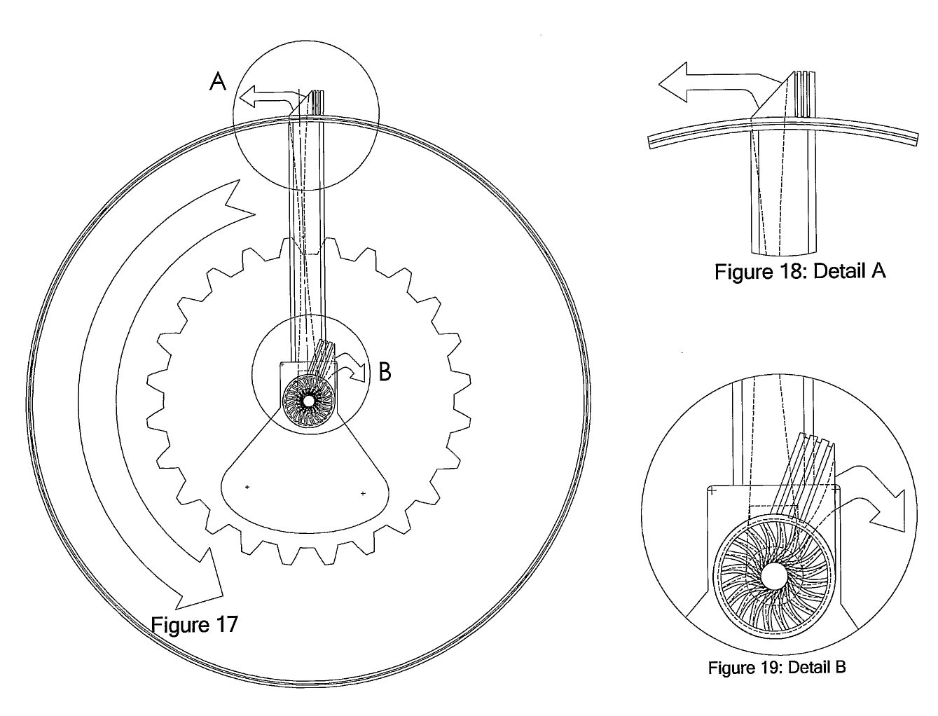

FIG. 18: Detail A of FIG. 17.

FIG. 19: Detail B of FIG. 17.

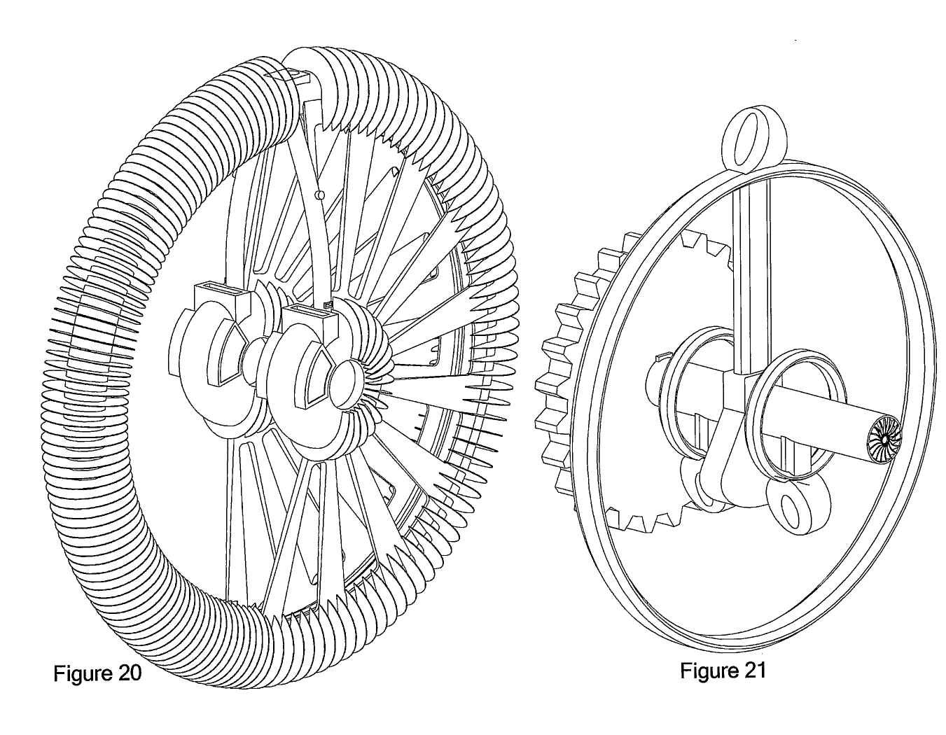

FIG. 20: The fixed block of the motor in case of the external air-cooling.

FIG. 21: The compression-pistons located on the arms which transfer the motion of the engine-shaft to the compression-pistons.

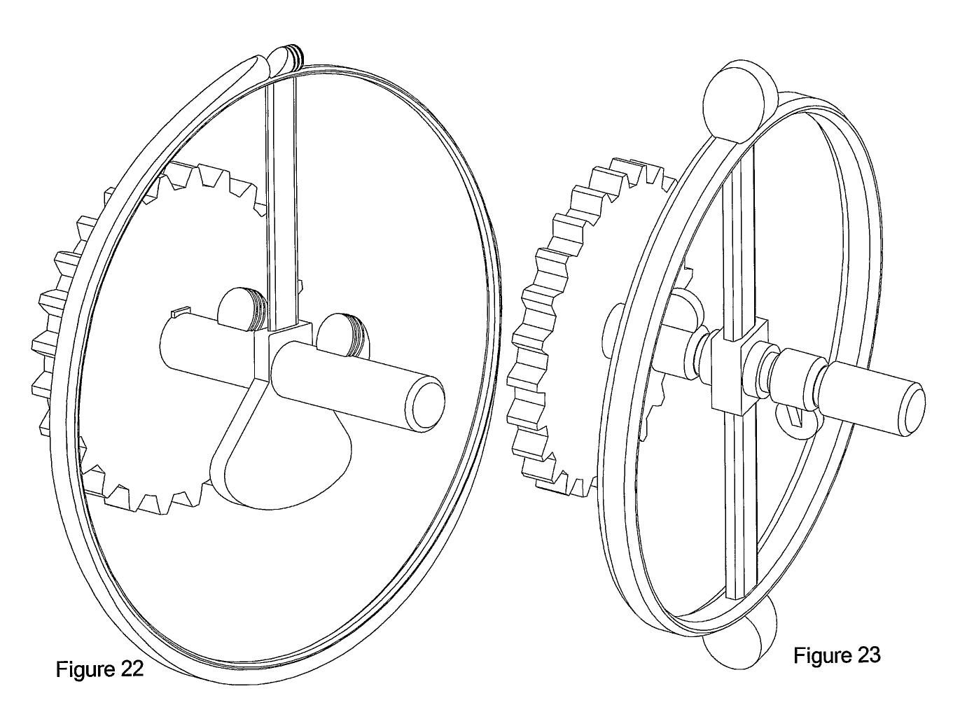

FIG. 22: The moving part of the engine where the rotating wall of the combustion chamber has a changing cross-section in order to retain the pressure in high levels during the expansion of the exhaust gases.

FIG. 23: FIG. 15 with a couple of expansion-pistons.

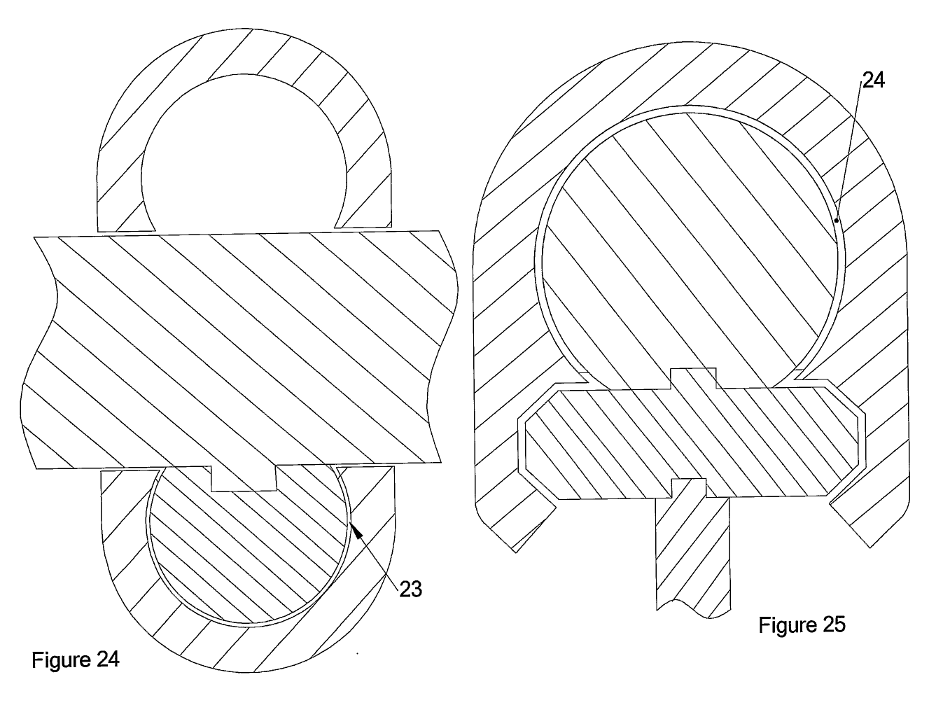

FIG. 24: the sealing of the compression-chamber and piston.

FIG. 25: the sealing of the combustion-chamber and piston.

The motor consists of four moving and one stable part which are depicted in the FIGS. 2 to 6:
The stationary external block of the engine (FIG. 2) comprising of the combustion-expansion chamber (1), the induction-compression chambers (2α and 2β), the pressure chambers (3α and 3β) and the air filters (4α,4β,4γ and 4δ). The air filters are located on the shells of the compression chambers in the inlet openings of the atmospheric air. In the figures, the air-filters are located on both sides of every compression chamber creating two inlets of atmospheric air in every chamber. The pressure chambers may have every possible shape. However, in the figures a canal-shape is chosen so that the chamber will have the minimum possible volume. On the shell (1) two fuel injectors (7α and 7β) and two spark-plugs (8α and 8β) are fitted. The numbers 6 and 12 represent the sliding ports of compression- and expansion-chamber, respectively. The place (10) is the point where the exhaust gases enter into the exhaust outlet in order to be removed.
The moving part (see FIGS. 5 and 6) comprising of the engine-shaft (16), the compression pistons (13α and 13β), the motion-arm (15) and the expansion piston (14). The choice of using two compression pistons and, correspondingly, two compression chambers as well as two pressure chambers is not necessary. A couple of them are used only to balance the engine-shaft. Only a single compression piston could be used and, correspondingly, a single pressure- and compression-chamber. Round the engine-shaft a cogwheel is located indicatively (17) through a wedge (18) for the transmission of the engine-shaft's motion to the gear box.
The sliding port (12) of the combustion chamber (1), (FIG. 5). The sliding port, when it is closed, is through a spring pressed on the surface of the moving wall of the combustion chamber in order to prevent the mixing of the fuel-air mixture with the exhaust gases of the previous operating cycle.
The sliding ports (6α and 6β) of the compression chambers (2α and 2β), (FIG. 5). These sliding ports, when they are closed, are pressed by a spring on the surface of the engine-shaft in order to prevent the communication of the compressed air or air-fuel mixture with the atmospheric air of the intake chamber.
The valves (5, 9 and 11) (FIG. 2 to 4) of the pressure chambers (3α and 3β) for the communication of the pressure chamber with the other chambers and for the control of its pressure. The numbers (5α and 5β) represent the relief-valves for avoiding the exaggerated increase of the pressure inside the pressure chamber. The numbers (11α and 11β) represent the one-way valves for the communication of the compression chambers with the pressure chambers. The numbers (9α and 9β) represent the one-way valves for the communication of the pressure chambers with the combustion chamber.

The figures depict only one side of the motor. Therefore, only one pressure chamber and one compression chamber are visible, but, obviously, everything that is mentioned about them concerns the operation of the other pressure and compression chambers, too. That means that the description is referred synchronously to the couple of pressure and compression chambers. Finally, there are flow arrows in the figures which show the position and direction of the working medium. For the current motor, the working medium doesn't remain the same through the operating cycle, but changes inside the pressure chamber. More precisely, the amount of air that is sucked and compressed in the compression chamber is stored in the pressure chamber and the same amount is fed from the pressure chamber into the combustion chamber.

Function Principal: [FIG. 7]: the rotation of the compression piston (13α) creates an area of very low pressure behind it which forces atmospheric air to enter into the compression chamber (2α) through the air filters (4α and 4β).

[FIG. 8]: the sliding ports (6α and 6β) are wide open permitting the rotation of the compression pistons inside the compression chambers without any essential resistance. Once the whole volume of the compression chamber is covered with atmospheric air, the combustion air circulates unblocked inside the compression chamber.

[FIG. 9]: the pistons (13α) and (13β) are coming to the desired position in order to begin the compression process (angle φ). The angle φ is the angle that specifies the compression's volume and, subsequently, the amount of air that will be compressed in every operating cycle. Thus, changing the value of the angle, changes the cubic capacity of the motor, too. The cubic capacity in this engine is the volume of air that is compressed. The value of the angle φ is essentially determined by the timing of the sliding ports. The timing of these ports regulates the volume of the combustion air that will be compressed. Such a regulation is very important for the fuel consumption as far as vehicles is concerned. If it is possible to electronically regulate the timing of the sliding ports, the duration of the operating cycle may be regulated according to the traffic conditions. That means that the driver of a vehicle with an engine of big cubic capacity will be able to adjust the timing of the sliding ports in order to reduce the amount of air and fuel that are led to the chambers when the traffic conditions do not permit the utilization of the maximum vehicles' acceleration. Once the piston reaches the position with angle φ calculated from the position of the sliding ports, the ports (6α) and (6β) close, trapping a significant part of the air that circulates inside the compression chambers. This volume is formed by the pistons (13α) and (13β) and the sliding ports (6α) and (6β), respectively. This space is the real compression's volume, while the rest part of the chamber is only for the intake of atmospheric air (induction chamber). The air that remains in the induction chamber is mixed with the new intake atmospheric air that enters the chamber through the air filters because of the low pressure that is created on the back side of the compression pistons as longs as the sliding ports (6α) and (6β) remain close.

[FIG. 10]: while the rotation of the compression pistons (13α and 13β) continues, the pressure of the trapped air (combustion air) increases continuously. Once the compression phase is complete, the pressure is high enough to make the valves (11α and 11β) open and allow the compressed air to enter from the compression chamber to the pressure chamber.

[FIG. 11]: Simultaneously, the valves (9α and 9β) open in order to allow the same amount of compressed air to leave the pressure chamber and to enter the combustion chamber so that the total pressure inside the pressure chamber remains the same as before the opening of the valves. Once the transfer of the compressed air from the pressure chamber to the combustion chamber is complete, the sliding ports (6α) and (6β) of the two compression chambers open so that the compression pistons can pass under them. On the other hand, the opening of these sliding ports equates the pressure of the compression chamber with the atmospheric pressure causing the direct closing of the valves 11 because of the pressure difference that prevails between the two sides of these valves. The valves 11 remain closed because of the pressure difference until the pressure in the compression chamber becomes again equal to or greater than the pressure inside the pressure chamber. The sliding ports remain open until the compression pistons come again in the right angle to start the compression phase of the next operating cycle (angle φ). While the valves 9 open and the compressed air enters from the pressure chambers to the combustion chambers, the fuel is injected in the combustion chamber. Because of the pressure difference between the pressure chamber and combustion chamber, the compressed air enters the combustion chamber with a high velocity and turbulence. Its entrance is favored from the low pressure that is created on the back side of the combustion piston. Thus, the fast mixture of the air with the fuel is ensured as well as the fast gasification of the fuel.

[FIG. 12—position 1 of the flow arrow]: The high pressure causes the mixture's auto-ignition, while a couple of spark-plugs (8α and 8β) (see FIG. 3) enforces the fast flame transmission through the whole volume of the combustion chamber, in order to, at least theoretically, utilize the advantages of the combustion under constant volume.

[FIG. 12—position 2 of the flow arrow]: the produced exhaust gases expand pushing the expansion piston (14) into a circular motion. The expansion piston (14) rotates the arm (15) and the arm rotates the engine-shaft (16), which, finally, rotates the compression pistons (13α and 13β). The expansion continues until the expansion piston reaches the closed sliding port (12).

In that moment, the sliding port (12) opens and while the expansion piston (14) passes over the valves 9α and 9β (see FIG. 11), the entering of the compressed air of the next operating cycle into the combustion chamber from the pressure chambers starts, preventing the entering of the exhaust gases into the combustion chamber, since the high pressure that prevails in the combustion chamber forces the exhaust gasses to move out through the outlet canal 10 (see FIG. 3)

[FIG. 12—position 3 of the flow arrow]: as the piston (14) passes the sliding port (12), the latter closes and the piston pushes the exhaust gases to move out through the outlet canal. This is the operation principal of the current motor and after that the whole procedure starts all over again.

The motor, as described above, has the following advantages:
The most important point to focus on this engine is the effort to position the combustion chamber as far away from the engine-shaft as possible, while the compression chamber must be located as close as possible to the engine-shaft. This principal aims to maximize the torque produced by the engine-shaft and to minimize the torque that the compression pistons need (through the engine-shaft) in order to compress either the combustion air or the fuel-air mixture. This distance between the compression chamber and the combustion chamber promises that the motor will have a torque much more than the existent or under research motors with the same fuel consumption. This distance is making necessary the existence of a third chamber, the pressure chamber, which will ensure that the thermodynamic conditions at the beginning of the combustion process are the same with the conditions at the end of the compression process, without requiring too high compression ratios and materials which can resist these ratios.
The fact that the timing of the compression sliding ports is not standard and can change, changing the amount of the combustion air, makes possible the regulation of the size of the compression volume according to the desires or requirements of the engine's user. In the case that the motor will operate as an atmospheric engine, the compression volume determines the mass of the combustion air and subsequently the fuel consumption through the air ratio λ. So, in the case of a car engine, the driver may regulate through an electronic system the timing of the sliding ports and consequently the fuel consumption according to his needs, if he is stuck in a traffic-jam or he is running on the high-way. In the first case, the vehicles with a big cubic capacity may reduce their compression ratio to a value that is quite enough only to move the vehicle and not to achieve great accelerations. This will reduce significantly the fuel consumption as well as the environmental pollution of the vehicles, especially in the case of high traffic.
In the case of vehicles, the ability of constructing a car-engine that may operate with a variety of compressed air according to the timing of the sliding ports allows the construction of one single engine for using it to a variety of versions of the same car (for instance sport version, station-wagon, SUV etc).
The construction cost of the current engine may be lower than the existent. On the other hand, its simple design makes easier the planning of the water-cooling system and lowers the energy that demands the cooling water for its circulation. In the case of a water cooling system, the simple design of the system makes easier the water circulation in all high temperature places of the engine without sudden direction changes and complicated routes. This reduces the pressure drop of the flow and the energy that the water plump demands. This can be easily shown in the FIG. 13 which depicts a water-cooled engine and the circulation of the cooling water. The cooling water covers all the external surface of the combustion-expansion and compression chamber. As far as the pressure chamber is concerned, since the gas in this chamber has a constant temperature during the whole operating cycle, it may be constructed using a material that affords this temperature and avoid the cooling of this chamber. Moreover, if the engine constructor desires to retain the high temperature of the stored medium, it is recommended not only to avoid the cooling of this chamber but also to use a temperature insulating material.
Because of the simple construction of the engine, the mechanical losses are less, while the fact that the pistons do not move reciprocatively, allows the achievement of a great number of rotations with low noise.
The exhaust gases, while they are pushed by the expansion piston direct to the outlet canal, they reach the canal with a very high kinetic energy and a continuous flow. Thus, they can be utilized for covering either the electrical requirements of the motor (such as the sliding ports' operations or the oil plump or water plump operation) or the mechanical requirements such as the operation of the fan in the case of an air cooling system.
The operating principle of the current engine may eliminate problems such as prior-ignition of the fuel. The motion of the combustion-expansion piston is one way and not reciprocative. Thus, the prior ignition doesn't resist to the rotation of the piston. On the other hand, the phenomenon of prior-ignition is less possible in this motor because it is present in the reciprocative motors only close to the upper dead point where the velocity of the piston is close to zero. Consequently, in the current motor, where the piston has low velocities only when the engine starts, it is considered that such problems will not be present.
Finally, the entering of the compressed air from the pressure chamber into the combustion chamber is favored by the pressure difference between the pressure chamber and the combustion chamber. In that moment, in the combustion chamber there is a very low pressure because of the motion of the expansion piston (the expansion's sliding port is closed). Thus, a high turbulent flow is developed which is efficient enough to create a homogenous mixture before the beginning of the combustion phase.

As far as the air cooling system is concerned, instead of using external cooling, through a fan and cooling wings (FIG. 14), it may be an internal cooling of the chambers (FIGS. 15 and 16). More precisely, since the pistons develop great laminar velocities during their rotation, it is interesting to utilize the developed centrifugal forces in order to cool the chambers. With an appropriate formation of the engine-shaft (16), the arm (15) as well as the pistons (13α,13β and 14) (formation of their interior like a Ventouri nozzle) (FIGS. 15 and 16), atmospheric air will be sucked, after it is cleared, it will be accelerated and guided against the interior walls of the chambers for their cooling.

This way of cooling does not need the air filters (4α) to (4δ). The air is filtered in various ways—even in the way the air is filtered in vehicles today—and then is guided on the edge of the engine-shaft, where the air is sucked through the embodied wings (20α) and (20β), located on the body of the engine-shaft, into the internal modulated canal (19) of the FIG. 16 and, after that, through the canals (21α), (21β) and (22) which have been modulated in the interior of the arm (15) as well as in the interior of the pistons (13α), (13β) and (14). Finally, the air hits against the internal walls of the chambers (2α), (2β) and (1) in order to cool them. The canals (21α), (21β) and (22) have in their interior the shape of a Ventouri nozzle (FIGS. 15 and 16) contributing to the acceleration of the cooling air before the latter hits against the walls of the chambers. The cooling of the combustion chamber comes before the combustion, while the cooling of the compression chamber follows the compression process (FIG. 17 to 19).

Moreover, the cooling of the whole motor can be supported by an external cooling like the FIG. 14 depicts, where the combustion chamber has external wings for its faster cooling. FIG. 20 better depicts the cooling wings like they are distributed on the three chambers.

In the case of a motor with a big cubic capacity, the compression pistons may be placed far from the engine-shaft, located on an arm which will transmit the motion of the engine-shaft to the pistons, like the FIG. 21 depicts (the depicted engine-shaft is coming from an air-cooling motor). This is suggested because the volume of the compression chamber is calculated by the relationship 2nRnd², where R is the rotation radius of the compression piston's center and d is the diameter of the chamber. Consequently, retaining the size of the compression piston constant (that means the diameter d), the volume of the chamber may be increased only by increasing the radius R. That means, the volume of the chamber increases by increasing the distance that the compression piston will cover.

In order to retain the pressure inside the expansion chamber high for as long as possible, the moving wall of the combustion chamber (22) may be modulated so that the volume of the expansion chamber is growing in a very slow rate during the motion of the expansion piston. This is possible if the distance between the two internal walls of the chamber—the internal wall of the shell and the upper surface of the moving wall—is not constant but these two surfaces converge gradually (FIG. 22).

In FIG. 5, the number (24) is for the inertia mass that has been added in order to balance the expansion piston. This mass can be replaced from another arm and expansion piston like FIG. 23 depicts. In this case, the combustion chamber is divided into two combustion-expansion chambers (1α) and (1β). The gases expand in the half length and every pressure chamber is connected with only one compression chamber. The compression pistons are located in positions with 180° angle difference in order to minimize the required volume of the pressure chamber.

Finally, as far as the sealing is concerned, this can be succeeded as follows:

The FIG. 24 refers to the sealing of the compression chamber (2α) where the rings (23) of the pistons are the same with the rings of the reciprocative motors. The cylindrical surface of the engine-shaft is sliding on the shell of the compression chamber, while o-rings prevent the oil to come inside the compression chamber.

The FIG. 25 refers to the expansion chamber (1) where the rings (24) of the pistons are the same with the rings of the reciprocative motors. The cylindrical surface of the moving wall is sliding on the shell of the expansion chamber with the aid of oil.

The engine-shaft, the motion-arm and the moving wall has been modulated in such a way that they seem like scotches of variable cross-section that contribute with the corresponding corrugation of the pistons and the moving wall in order to prevent the sliding between each other. In this way, the compression pistons are wedged on the engine-shaft and the expansion piston on the moving wall which is, finally, wedged on an arm. The cross-section of the scotches decreases according to the direction of the movement in order to enforce the wedging as the parts move.

1. Internal combustion rotary motor with at least two pistons, which are moving in a circular orbit with gudgeon the axis of the engine-shaft, and two chambers, the first for the intake and compression process (called compression chamber) and the other for the combustion and expansion process (called combustion chamber), characterized in that,
a) apart from the two fore-mentioned chambers, whose shape is concentric toroidal, there is one more chamber (called pressure chamber), interposed between the other two, where air or air-fuel mixture is stored under high pressure, allowing the location of the combustion chamber to be as far from the compression chamber as possible, while in every working cycle the intake and compressed air is not the same with the air that takes part in the combustion process,
b) the engine-shaft gets into motion from an attached—to it—arm, called motion-arm, on the free edge of which one of the pistons is located, called expansion piston, while the other piston, called compression piston, is positioned close to surface of the engine-shaft (the closer, the better) and is following the rotating motion of the engine-shaft, allowing the production of a great effective torque, because of the minimum torque requirement for the compression of the working medium, due to the short distance of the compression piston from the engine-shaft, and maximum torque production due to the longest possible distance of the expansion piston from the same shaft, depending on the length of the motion arm,
c) all pistons have a circular cross-section and are similar in shape with the up-to-date pistons of the reciprocative engines,
d) the compression and combustion chambers have sliding ports which are controlled to open and close in a way that they determine the compression ratio and the expansion ratio, accordingly, while the timing of the sliding ports in the compression chamber determines the compression volume, influencing directly the output power of the motor since it changes the amount of the used combustion air and fuel, respectively,
e) the connection of the pressure chamber with the other two chambers is controlled by valves, whose operation is controlled by the Engine Processor of the motor or, alternatively, by the pressure difference between the pressure- and compression-chamber and
f) finally, there is a relief valve in every pressure chamber that prevents the exaggerated increase of the pressure inside the pressure chamber because of the hot weather or high operation temperature.

2. Internal combustion engine, as claimed in claim 1, characterized in that the interior walls of the compression and combustion chambers are cooled by air, where atmospheric air, after it is cleared through filters, is sucked through wings located on the edges of the interior hollowed engine shaft, it is then accelerated through the developed centrifugal force as well as by the interior shape of the hollowed pistons and arms, in shape of a Ventouri nozzle, and, finally, it hits against the interior wall of the chambers in order to cool them, where in the case of the combustion chambers, this kind of cooling is ahead of the expansion piston's passing, while, in the case of the compression chambers the cooling follows the compression pistons' transit.

3. Internal combustion engine, as claimed in claim 1 or 2, characterized in that the compression chamber is formed by the outer cylindrical surface of the engine-shaft, the compression sliding port, the compression piston and a stationary toroidal shell, attached firmly on the frame of the motor, while the combustion chamber is formed by the combustion sliding port, the expansion piston, a stationary toroidal shell, attached firmly on the frame of the motor and a moving, rotating wall, ring in shape, which is firmly attached on the free edge of the motion arm.

4. Internal combustion engine, as claimed in the claims 1 or 2 or 3, characterized in that the compression pistons are directly attached on the engine-shaft in order to minimize the distance of the compression piston from the engine-shaft, while the compression chambers are in touch with the cylindrical outer surface of the engine-shaft.

5. Internal combustion engine, as claimed in the claims 1 or 2 or 3, characterized in that the compression pistons are not directly attached on the engine-shaft, but they are connected with it indirectly, through arms which transmit the motion of the engine shaft to the pistons, while the compression chambers are not in touch with the cylindrical outer surface of the engine-shaft, but they are formed by a stationary shell firmly attached on the frame of the engine and a rotating wall, ring in shape, which is firmly attached on the free edge of an arm which is directly attached on the engine shaft.

6. Internal combustion engine, as claimed in the claims 1 or 2 or 3 or 4 or 5, characterized in that there are two arms of the same length directly attached to the engine-shaft forming an angle of 180° between them, each of them having an expansion piston on its free edge dividing the combustion-expansion chamber in to two chambers of equal volume, where each of these two combustion-expansion chambers is connected only with one pressure-chamber.
